(19) United States
(12) Patent Application Publication
(10) Pub. No.: US 2005/0163292 A1
(43) Pub. Date: Jul. 28, 2005

(54) Method and system for displaying data on a telecommunication terminal

(76) Inventor: Gunther Stehlik, Wien (AU)

Correspondence Address: Siemens Corporation;Intellectual Property Department, 170 Wood Avenue South, Iselin, NJ, 08830, US

(21) Appl. No.: 10/501,102

(22) PCT Filed: Dec. 18, 2002
(86) PCT No.: PCT/EP02/14473

(30) Foreign Application Priority Data
Jan. 7, 2002 (DE) 102-00-295.9

(51) Int. Cl. H04M 11/00; G06F 15/173

(52) U.S. Cl. 379/93.23; 709/238

(57) ABSTRACT

In the English translation document, please add the paragraph at page 22 line 1, after the newly added ABSTRACT section heading, as follows: The invention relates to a method for displaying data on a telecommunications terminal, whereby said terminal is used to establish a voice connection with a partner via a communications network at least over certain routes, using packet-oriented, connectionless data transmission. According to the invention, after a signalling step for establishing a connection from the telecommunications terminal to the partner, information relating to the data to be displayed is transmitted by said partner to the telecommunications terminal via the communications network, or the transmission of said information to the telecommunications terminal is initiated by the partner. The received information is accepted and evaluated by the telecommunications terminal and the data is optionally loaded onto the telecommunications terminal and is output using at least one display element. The invention also relates to a corresponding system.

### CROSS REFERENCE TO RELATED APPLICATIONS

This application is the US National Stage of International Application No. PCT/EP02/14473 filed Dec. 18, 2002 and claims the benefit thereof. The International Application claims the benefit of German application No. 10200295.9 filed Jan. 7, 2002, both of the applications are incorporated by reference herein in their entirety.

### FIELD OF INVENTION

The invention relates to a method for displaying data on a telecommunications terminal, whereby the telecommunications terminal can be used to establish a voice connection with a partner via a communications network at least over certain routes using a packet-oriented, connectionless data transmission.

The invention also relates to a system for displaying data on a telecommunications terminal, with which the telecommunications terminal is set up to establish a voice connection with a partner via a communications network at least over certain routes using a packet-oriented, connectionless data transmission.

### BACKGROUND OF INVENTION

Many users are familiar with the acoustic menu guide from conventional telephony. When making a call to a call center, hotlines, exchanges, etc., callers are frequently not connected directly to a partner initially, instead various menu points are specified acoustically, each with a number, and callers press the corresponding number either to reach a further sub-point or the required partner.

The disadvantages of this menu guide are adequately known. In particular when there is a plurality of menu points or interlaced menus, it is often difficult for users to discern the corresponding menu point and they have to listen to the menu again, thereby wasting time and money.

### SUMMARY OF INVENTION

It is therefore one object of the invention to eliminate such disadvantages and configure such a menu guide in a manner that is significantly more user-friendly and simple for users of data-based telecommunications terminals.

This object is achieved with a method as mentioned above in that according to the invention after a signaling step for establishing a connection from the telecommunications terminal to the partner, information relating to the data to be displayed is transmitted by said partner to the telecommunications terminal via the communications network or the transmission of said information to the telecommunications terminal is initiated by the partner. The received information is accepted and evaluated by the telecommunications terminal and the data is optionally loaded onto the telecommunications terminal and is output using at least one display element.

In this way data, which for example contains the menu guide in graphic form, can be transferred to the telecommunications terminal and displayed there, so that it can be easily read by users and is optically available for a relatively long period, so that users can make their selection in a significantly easier manner.

The invention however proves to be advantageous not only for use in conjunction with the menu guide referred to, as will be examined in more detail below.

To use the invention in conjunction with a menu guide as referred to above, it is necessary for the information to be transmitted directly after the signaling step for establishing a connection and before a connection is established.

It can however be expedient for the information to be transmitted after a connection has been established. This is particularly

appropriate, when information is to be transmitted perhaps as an accompaniment to a telephone call and then displayed to the user on their telecommunications terminal. In principle provision can also be made thereby for advertising information for example to be transmitted to the user.

Naturally provision can also be made thereby for information to be transmitted on the one hand before a connection is established and then for a further transmission of information to take place after a connection is established.

There are various options for transmitting the data to the calling telecommunications terminal and in this context it is also relevant how the information being transmitted to the telecommunications terminal is configured.

In one specific embodiment for example the information contains at least the data to be displayed, i.e. the data from the partner or another station set up for this purpose is transmitted in essentially the same manner to the calling telecommunications terminal.

However the information can also contain a reference to a data server, from which the data can be transmitted to the telecommunications terminal. The options thereby exist in principle for establishing a connection with the telecommunications terminal to the data server and loading the corresponding data but it is also possible for only one connection to be established, which is then kept open, and the data is then sent from the data server to the telecommunications terminal. The connection is then generally established automatically with the telecommunications terminal after receipt of the reference.

Regardless of whether the information already contains the data to be displayed or only for example a reference to where the data is located, it can be favorable for the information to be sent directly from the partner to the telecommunications terminal. In such a case the correspondingly set up partner operates as the “data server”, i.e. it is correspondingly equipped on the one hand to have available the information and/or data and on the other hand also to transmit (it to a calling terminal.

In a different embodiment of the invention, the partner prompts a data server associated with it to transmit the information to the telecommunications terminal. In this case the partner only has to be set up to transmit corresponding signals to a data server, so that said data server then forwards the information to the calling telecommunications terminal and can therefore be configured in a correspondingly simpler manner. On the other hand of course at least one further data server is necessary for this but this can then also be used for a plurality of partners. Naturally such a solution is also generally more flexible, as when there is one data server for a plurality of partners, in the case of any changes the data only has to be changed on one device, namely the data server, and not at every partner.

Generally a connection is established to the data server or partner by the calling telecommunications terminal with a program element for displaying data and the information is transmitted to the telecommunications terminal and displayed on this via said connection.

An HTML browser is used as the program element for example.

In principle the program element for displaying data can be configured separately from a program element for establishing a data-based voice connection but it is especially advantageous for the two program elements to be configured as a single program.

It is especially favorable for the data to be available in the form of at least one file created using a markup language. When using data in such a form, it is also possible in addition to the graphic displays of the data for said data to allow actions on the part of the user of the telecommunications terminal. For example it is possible for the displayed data, perhaps in the form of an HTML page, to offer further links, which the user can then dial up and to which said user can then be connected.

Staying with the example of the menu guide, it is also possible for the individual menu points to represent links or references, which either take the user to a specific internet page for orders, supply further information about a product or which, after dialing, establish a connection to a specific extension link for example in the case of a partner configured as a private branch exchange.

In one specific embodiment of the invention in the context of establishing a connection between the telecommunications terminal and the partner, call control messages are exchanged, whereby the call control messages are used a) in some instances on the telecommunications terminal to start the program element for displaying data, b) to initiate establishment of a connection to the data server or partner and c) to keep open the data connection from the data server or the partner for the purpose of data transmission from the data server to the telecommunications terminal. The program element for displaying is thereby only started, if it has not yet

been started. If for example the program element for displaying and the program element for establishing a call are integrated in a shared program, this is of course no longer necessary.

H.323 signaling is used for example to establish a connection.

In the context of the call control messages for example a capability set is agreed between the telecommunications terminal and the partner, whereby the capability set is then extended to include an HTML capability for example.

The two terminals can be informed via these capability sets of the options offered by the partner, for example whether it offers a program element for displaying data. The HTML capability extension means that a data connection established on the part of the calling terminal or the data channel for transferring data from the data server or the partner is kept open, so that the data can be transmitted from the data server/partner to the telecommunications terminal and data cannot only be loaded with the telecommunications terminal running the program element, perhaps the HTML browser.

In another variant of the invention, SIP signaling is used to establish a connection. As with the procedure described above relating to call control messages in conjunction with H.323 signaling, SIP messages, for example the optional “Call Info” field, can be used correspondingly, so that the functionality described above is essentially available.

The invention is also achieved with a system as mentioned above in that according to the invention the partner is set up to send information relating to the data to be displayed to the telecommunications terminal via the communications network or to

initiate the transmission of this information, and the telecommunications terminal is set up to accept and analyze the information, optionally load the data and display it using at least one display element.

Advantageous embodiments of this system have already been examined in more detail in conjunction with the inventive method.

### BRIEF DESCRIPTION OF THE DRAWINGS

The invention is described in more detail below with reference to the drawing, in which:

FIG. 1 shows a representation of the principles of a telecommunications network with connected terminals in conjunction with the invention,

FIG. 2 shows a further telecommunications network,

FIG. 3 shows an exemplary inventive signaling operation and

FIG. 4 shows an example of the structure of an HTML page displayed at a calling terminal.

### DETAILED DESCRIPTION OF INVENTION

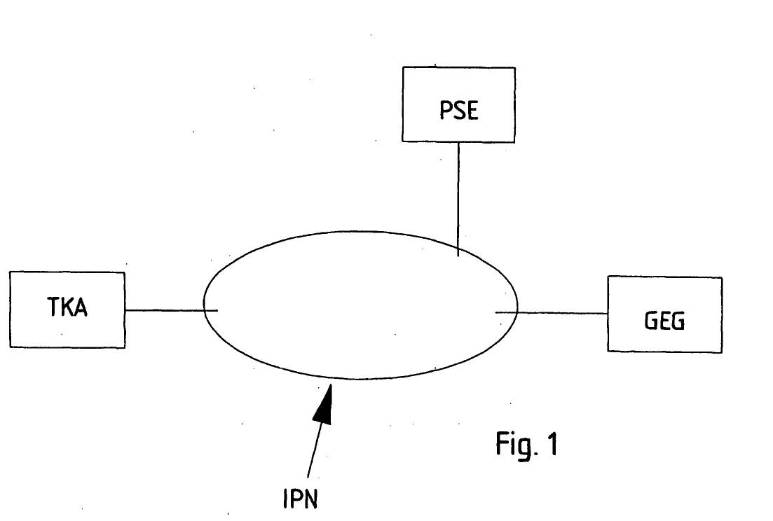

FIG. 1 shows a telecommunications terminal TKA, which can be connected via a communications network IPN to a partner GEG for example for the purpose of a voice connection. The first telecommunications terminal TKA is a terminal, which is set up for the packet-oriented, connectionless transmission of data via a corresponding telecommunications network IPN. For example this data transmission takes place using the known IP protocol (Internet Protocol). With this layer 3 protocol data packets are transported from a sender via a plurality of networks to a recipient, whereby transmission is packet-oriented, connectionless and not guaranteed.

The data packets (also referred to as datagrams) are transported by the IP protocol as mutually independent data packets (even when the senders and recipients are identical).

With a correspondingly set up—preferably by means of software—terminal TKA it is now also possible to set up voice connections via this packet-oriented, connectionless data transmission, for example by means of VoIP (Voice over IP), with which the IP protocol is also used in particular for voice transmission.

VoIP is defined by the ITU standard H.323, which represents an extension of the standard H.320 for videoconferences via ISDN. H.323 includes data-packet-switched networks in this definition. Based on the realtime transport protocol RTP, H.323 can also be used for video transmissions via the internet.

H.323 is an international ITU standard for voice, data and video communications via packet-oriented networks, which defines the specific capabilities of terminals in the IP environment. H.323 forms the basis for VoIP and was developed for the transmission of multimedia applications. This standard is used to define realtime communications in LANs, which cannot offer guaranteed quality of service. The H.323 standard comprises a series of protocols for signaling, for exchanging terminal functionalities, for connection control, for exchanging status information and for data flow control. The multimedia standard recognizes three different signaling functions between the H.245 control channel, the Q.931 signaling channel and the RAS (Registration, Admission and Status) channel. Communications itself, i.e. voice, operates directly from communications end-point to communications end-point, whereby certain tasks are assigned to what is known as a gatekeeper, such as the ‘admission control’ referred to, and ‘address translation’, which we will not look at in any more detail here.

Also known is the Session Initiation Protocol SIP, which is a standard proposed by the Internet Engineering Task Force (IETF) for the transmission of realtime data via packet-based networks. The SIP protocol is functionally comparable to the H.323 protocol and can set up, modify and terminate interactive communications services. SIP information can be transported via TCP (Transmission Control Protocol) or UDP (User Datagram Protocol). SIP has an open, internet-based structure and allows CLASS (Custom Local Area Signaling Service) features, such as caller ID or call forwarding in IP-based networks. SIP is responsible for call signaling, user location and registration. Quality of service, directory access and session procedures are dealt with by other protocols. Communications itself, i.e. voice, operates directly from communications end-point to communications end-point, whereby certain tasks are assigned to what is known as a SIP proxy, such as location of the called user.

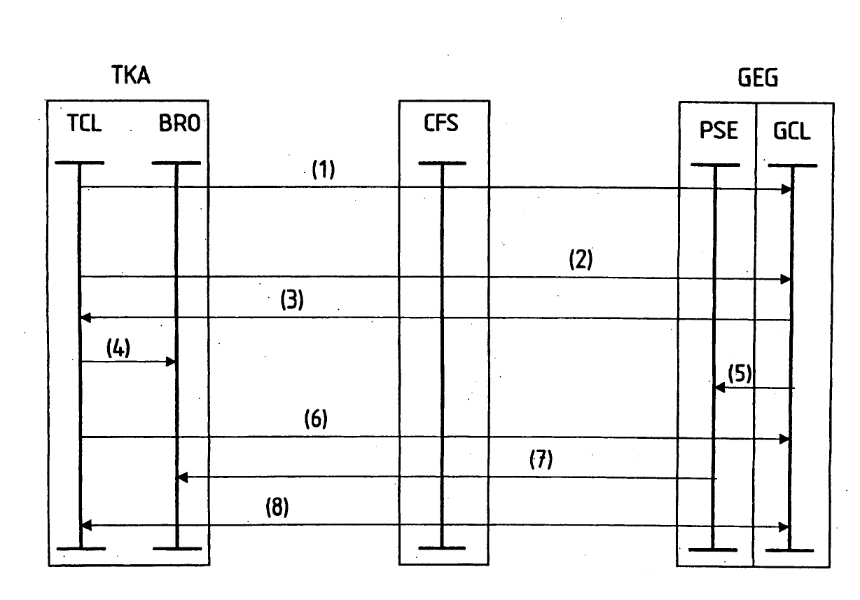

A connection is now established with the terminal TKA via the telecommunications network IPN, for example the internet, to a partner GEG, which is also linked to the communications network IPN, for example directly or via other networks. The terminal TKA is a specific “internet telephone” for example or a personal computer, which is set up with corresponding software for internet telephony (VoIP). The terminal TKA also has display elements BRO for displaying data, which is either loaded by the terminal TKA via the network or sent via the network IPN to the terminal. The display element BRO (FIG. 3) is what is known as a browser for example, i.e. software set up correspondingly to display such data, whereby said data is then preferably available in what is known as markup language, for example HTML (Hypertext Markup Language) or XML (Extended Markup Language). In the context of the invention it is favorable, if the display element BRO is also integrated in the telephone software but the display element and telephone software can also be completely separate.

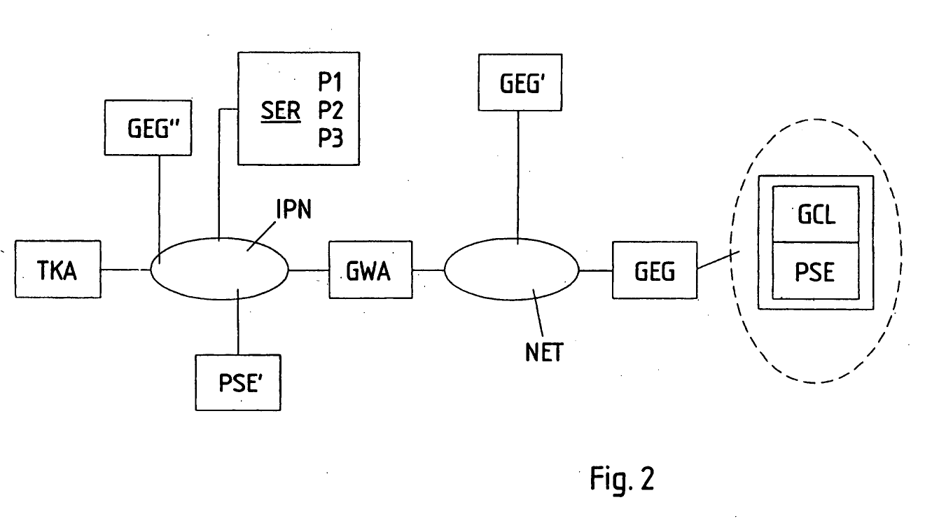

The partner GEG is also an IP-based terminal for the purposes of simplicity in this representation but this does not have to be the case, as described in more detail below with reference to FIG. 2.

With reference to FIG. 3 the inventive sequence is now as follows for establishing a connection from the terminal TKA to the partner GEG.

With a signaling client TCL as a component of the telecommunications terminal TKA in a first stage (1) the signaling step for establishing a connection is first executed with a corresponding client GCL of the partner GEG. The two clients TCL, GCL thereby use for example the H.323 protocol mentioned above or the SIP protocol but other protocols are also conceivable and it is of course also possible for each of the clients to use a different protocol, whereby in this latter case corresponding mediation functions such as gateways have of course to be provided as protocol translators.

Control messages are exchanged in the context of establishing a connection between the clients TCL, GCL, therefore when H.323 signaling is used, H.245 messages are exchanged via a control channel (see e.g. ITU-T H.245). In the context of said control

messages call control messages are also exchanged, in other words capability sets are agreed between the two clients, with which service-independent functions are provided, from which various services can be derived. Such a standardized capability set is now for example extended to include an HTML capability, which makes it possible to transmit HTML pages for example to the terminal TKA establishing the call signaling and to display them there, as described in more detail below.

In stage (2) the client TCL now uses such a capability set to indicate in the context of a control message that it is able to receive HTML pages and to use a corresponding browser element to display what is confirmed in stage (3) by means of a corresponding acknowledge message on the part of the client GCL, whereupon the browser BRO is started by the client TCL of the partner TKA (4). In principle it is also possible for the browser BRO to be a component of the client software TCL, so that it is no longer necessary to start the browser BRO separately.

The client GCL of the called partner GEG now uses push technology in stage (5) to prompt a server PSE associated with it to transmit information, for example in the form of HTML pages, to the browser BRO of the calling terminal TKA.

In stage (6) successful channel set-up for the RTP voice connection is confirmed between the communications end-points using the H.245 call control message “openLogicalChannelAck”.

Content perhaps in the form of HTML pages is thereby transmitted via an HTTP (Hypertext Transfer Protocol) connection initially established from the browser BRO to the push server PSE, which is no longer closed by the push server PSE, by this to the partner TKA and displayed there with the browser BRO (7).

Finally then a further voice connection generally takes place between the clients TCL and GCL, for example using the RTP protocol (8) or the SIP protocol.

For the sake of completeness in FIG. 3 the call feature server CFS is shown as part of an H.323 gatekeeper, which is responsible for call signaling (H.225) tasks. However this server is a specific solution, which is neither necessary for the operation of the invention nor in principle necessary at all and should therefore not restrict the invention in any manner.

This is a Siemens-specific solution and is specifically necessary for the interworking of H.323 users with PSTN users and is not at all necessary for a purely H.323 solution.

The following should be noted in respect of the basic sequence described above. The invention is not solely restricted to the transmission of HTML pages. In principle the transmission of information in any form is possible but the use of a markup language such as HTML, XML, etc. of course lends itself especially to the invention.

The partner GEG essentially comprises a client GCL for setting up and establishing a call connection. In the simplest instance—as shown in FIG. 1—it is a VoIP terminal, for example an internet telephone or a correspondingly set up computer. In principle however it is also possible for it to be a conventional telephone terminal, as described below with reference to FIG. 2.

FIG. 2 again shows a telecommunications terminal TKA as discussed above, which is linked to a network IPN, such as the internet.

As shown in FIG. 1 the push server PSE can be configured separately from the partner GEG and can be connected to the network IPN or another communications network, which is connected to the network IPN. In this case the client GCL must be set up, for example on receipt of the signaling to establish a call from a terminal TKA, to prompt the server PSE by means of corresponding control signals to send corresponding information to the terminal TKA establishing the call, for example in the form of HTML pages, so that these can be displayed there.

FIG. 3 shows the case where the terminal TKA is again a VoIP device, which is linked to a corresponding network IPN and which for example controls the signaling via H.323 or SIP, but the called terminal GEG is either a conventional analog terminal GEG or a terminal, which uses a different signaling from the calling terminal TKA. According to FIG. 3 the terminal GEG is thereby linked to a telecommunications network NET.

It is also possible to establish a connection between the terminals TKA and GEG in such cases. Conversion between the different protocols, e.g. from H.225 signaling to PSTN signaling or H.323 signaling to SIP protocol then takes place via a gateway GWA. The stages (6), (7) and (8) according to FIG. 3 could then not take place as shown on the same medium, as the information to be displayed has in any case to be transmitted directly via a data network and not via the PSTN network NET and the language has to be converted from RTP via an appropriate gateway from/into digital coding of the PSTN.

As can also be seen from FIG. 3—except where the partner GEG is an analog telephone—the partner GEG can, as discussed briefly above, comprise a call client GCL and a push server PSE, which will however generally only be the case, when the terminal GEG is a computer or a computer unit or for example a call center; in such cases the partner GEG or its call client GCL is generally also able to execute packet-oriented and connectionless voice communications, for example via VoIP.

With such terminals the push server PSE′ can also be configured separately from the device GEG and the push server PSE′ is prompted by the terminal GEG or the call client GCL to transmit corresponding information to the calling terminal TKA.

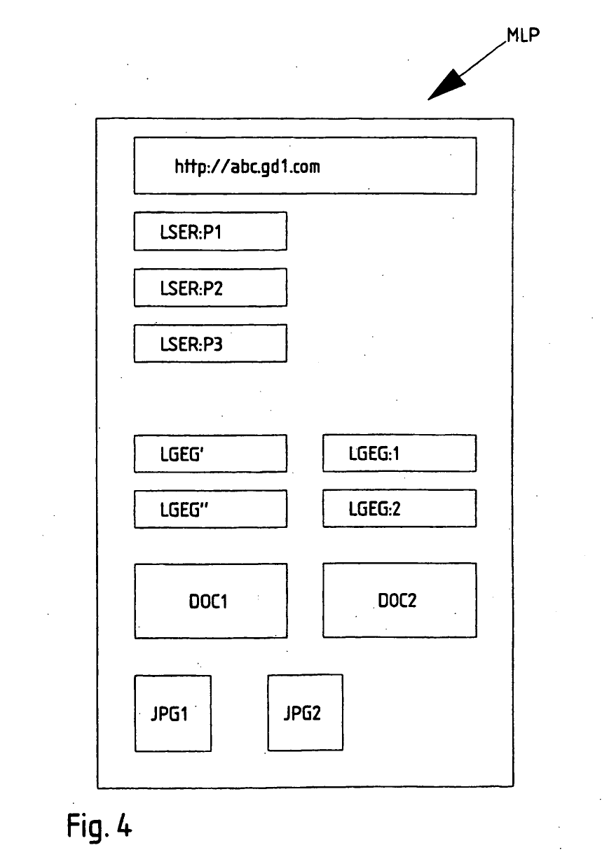

FIG. 4 shows an exemplary, schematic representation of an HTML page MLP, as transmitted from the terminal GEG or a push server PSE, PSE′ to a calling terminal TKA. The page MLP for example contains links LSER:P1, LSER:P2, LSER:P3, i.e. references perhaps to specific internet pages P1, P2, P3, which are stored on one or a plurality of other servers SER. Such links can also refer to pages on the (correspondingly configured) terminal GEG or the push server PSE, PSE′. The links can of course also be configured so that a call connection is established to another terminal GEG′, GEG″ (links LGEG′, LGEG″) or perhaps when the first called partner GEG is for example a private branch exchange or a call center, to an extension of the partner GEG (links LGEG:1, LGEG:2).

The HTML page MLP can of course alternatively or additionally also contain other information such as images JPG1, JPG2, text DOC1, DOC2, etc. This information can be transmitted from the push server to the calling telecommunications terminal TKA either after the signaling step for establishing a connection or before a connection is actually established. This is primarily of interest and significance when a connection is only made based on transmitted information by a corresponding selection. Transmission can however also (still) take place after a call has been established, for example in this way additional information about a discussed topic or object can be transmitted to the caller.

1-28. (canceled)

29. A method for displaying data on a telecommunications terminal, wherein
the telecommunications terminal is used to establish a voice connection with a partner via a communications network at least over certain routes, using packet-oriented, connectionless data transmission, wherein
after a signaling step for establishing a connection from the telecommunications terminal to the partner, information is received and evaluated by the telecommunications terminal and data, which is assigned to the information, is output using at least one display element, wherein
the information is transmitted from the partner via the communications network to the telecommunications terminal or the transmission of the information to the telecommunications terminal is initiated by the partner, and wherein
the data assigned to the information is loaded onto the telecommunications terminal as a direct consequence of the signaling step for establishing a connection:

30. A method according to claim 29, wherein the information is transmitted directly after the signaling step for establishing a connection and before a connection is established.

31. A method according to claim 29, wherein the information is transmitted after a connection has been established.

32. A method according to claim 29, wherein the information contains at least the data to be displayed.

33. A method according to claim 29, wherein the information comprises a reference to a data server, from which the data can be transmitted to the telecommunications terminal.

34. A method according to claim 29, wherein the information is sent directly from the partner to the telecommunications terminal.

35. A method according to claim 29, wherein the partner prompts a data server associated with it to transmit the information to the telecommunications terminal.

36. A method according to claim 29, wherein a connection is established from the calling telecommunications terminal to the data server or the partner with a display element and the information is transmitted to the telecommunications terminal and displayed on it via the connection.

37. A method according to claim 36, wherein an HTML browser is used as the display element.

38. A method according to claim 29, wherein the data is available in the form of at least one file created using a markup language.

39. A method according to claim 29, wherein
in the context of establishing a connection, call control messages are exchanged between the telecommunications terminal and the partner, and wherein
the call control messages are used:
a) in some instances on the telecommunications terminal to start the display element for displaying data,
b) to initiate establishment of a connection to the data server or the partner, and
c) to keep open the data connection from the data server or the partner for the purpose of data transmission from the data server to the telecommunications terminal.

40. A method according to claim 29, wherein H.323 signaling is used to establish a connection.

41. A method according to claim 39, wherein in the context of the call control messages, a capability set is agreed between the telecommunications terminal and the partner, and wherein the capability set is extended to include an HTML capability.

42. A method according to claim 29, wherein SIP signaling is used to establish a connection.

43. A method for displaying data on a telecommunications terminal, comprising:
establishing a voice connection with a partner via a communications network by the telecommunications terminal;
transmitting information from the partner via the communications network to the telecommunications terminal or initiating the transmission of the information to the telecommunications terminal by the partner;
receiving and evaluating information by the telecommunications terminal; and
outputting data assigned to the information on a display element, wherein
the data assigned to the information is loaded onto the telecommunications terminal as a direct consequence of a signaling step for establishing the voice connection.

44. A method according to claim 43, wherein the voice connection is established at least over certain routes, using packet-oriented, connectionless data transmission.

45. A system for displaying data on a telecommunications terminal, comprising:
a telecommunications terminal adapted to establish a voice connection with a partner via a communications network at least over certain routes, using packet-oriented, connectionless data transmission, wherein the telecommunications terminal is adapted to receive and evaluate information and display data assigned to the information optionally using at least one display element; and
a partner adapted to send information relating to the data to be displayed to the telecommunications terminal via the communications network or adapted to initiate the transmission of the information as a direct consequence of a signaling step for establishing the voice connection, wherein
the telecommunications terminal is adapted to load the data assigned to the information as a direct consequence of the signaling step for establishing the voice connection.

46. A system according to claim 45, wherein the system is adapted to transmit the information directly after the signaling step for establishing a connection and before a connection is established.

47. A system according to claim 45, wherein the system is adapted to transmit the information after a connection has been established.

48. A system according to claim 45, wherein the information comprises at least the data to be displayed.

49. A system according to claim 45, wherein the information contains a reference to a data server, from which the data can be transmitted to the telecommunications terminal.

50. A system according to claim 45, wherein the partner is adapted to send the information directly to the telecommunications terminal.

51. A system according to claim 45, wherein the partner is adapted to prompt a data server associated with it to transmit the information to the telecommunications terminal.

52. A system according to claim 45, wherein the telecommunications terminal is adapted to establish a connection with a display element to the data server or to the partner and the data server or the partner are adapted to transmit the information to the telecommunications terminal via the connection.

53. A system according to claim 52, wherein an HTML browser is used as the display element.

54. A system according to claim 45, wherein the data is available in the form of at least one file created using a markup language.

55. A system according to claim 45, wherein
the telecommunications terminal and the partner are adapted to exchange call control messages in the context of establishing a connection, and wherein
the call control messages are used:
a) in some instances on the telecommunications terminal to start the display element,
b) to initiate establishment of a connection to the data server or the partner and
c) to keep open the data connection from the data server or the partner for the purpose of data transmission from the data server to the telecommunications terminal.

56. A system according to claim 45, wherein H.323 signaling is used to establish a connection.

57. A system according to claim 55, wherein in the context of the call control messages, a capability set is agreed between the telecommunications terminal and the partner, whereby the capability set is extended to include an HTML capability.

58. A system according to claim 45, wherein SIP signaling is used to establish a connection.

59. A telecommunications terminal, wherein
the telecommunications terminal is adapted to establish a voice connection with a partner via a communications network at least over certain routes, using packet-oriented, connectionless data transmission, wherein the telecommunications terminal is adapted to receive and evaluate information and display data assigned to the information optionally using at least one display element; and wherein
the telecommunications terminal is adapted to load data assigned to the information as a direct consequence of a signaling step for establishing the voice connection.
